(19) United States
(12) Patent Application Publication
(10) Pub. No.: US 2026/0119341 A1
(43) Pub. Date: Apr. 30, 2026

(54) ELECTRONIC DEVICE PROVIDING DATA BACK-UP OPERATION, METHOD OF OPERATING THE SAME, AND METHOD OF OPERATING ELECTRONIC SYSTEM HAVING THE SAME

(71) Applicant: Samsung Electronics Co., Ltd., Suwon-si (KR)

(72) Inventors: Sang-ho YI, Suwon-si (KR); Youngseol KIM, Suwon-si (KR); Kyungduk LEE, Suwon-si (KR)

(73) Assignee: Samsung Electronics Co., Ltd., Suwon-si (KR)

(21) Appl. No.: 19/328,960

(22) Filed: Sep. 15, 2025

(30) Foreign Application Priority Data
Oct. 29, 2024 (KR) 10-2024-0149528

(51) Int. Cl. G06F 11/14

(52) U.S. Cl. CPC G06F 11/1469; G06F 2201/80

(57) ABSTRACT

Disclosed is an operating method of an electronic device which includes a device controller, a volatile memory device, a non-volatile memory device, and a recovery device. The operating method includes backing up copy data of user data stored in the volatile memory device to the non-volatile memory device based on health information of the volatile memory device, providing a read request for at least a portion of the user data to the volatile memory device, performing an error verification operation based on the read request, storing first metadata indicating that an uncorrectable error has occurred, based on a result of the error verification operation, restoring the user data with the copy data, based on a result of monitoring the first metadata of the volatile memory device, and providing the at least a portion of the user data to the device controller.

### CROSS-REFERENCE TO RELATED APPLICATIONS

This application claims priority under 35 U.S.C. § 119 to Korean Patent Application No. 10-2024-0149528 filed on Oct. 29, 2024, in the Korean Intellectual Property Office, the disclosure of which is incorporated by reference herein in its entirety.

### BACKGROUND

Example embodiments of the present disclosure described herein relate to electronic devices, and more particularly, relate to electronic devices providing a data back-up operation, operating methods thereof, and/or operating methods of an electronic system including the same.

A memory device stores data in response to a write request and outputs data stored therein in response to a read request. For example, the memory device is classified as a volatile memory device, which loses data stored therein when a power is turned off, such as a dynamic random access memory (DRAM) device or a static RAM (SRAM) device, or a non-volatile memory device, which retains data stored therein even when a power is turned off, such as a flash memory device, a phase-change RAM (PRAM), a magnetic RAM (MRAM), or a resistive RAM (RRAM). The non-volatile memory device may be used as a storage device storing a large amount of data.

The volatile memory device may support operations of reading and writing data. The volatile memory device may store data, and may provide the stored data to a host device in response to a read command of the host device. An error may occur in the data stored in the volatile memory device. The error of the data to be provided from the volatile memory device to the host device may cause a critical system issue. Accordingly, the integrity of data to be provided from the volatile memory device to the host device may be desired or required.

### SUMMARY

Example embodiments of the present disclosure provide electronic devices providing a data back-up operation, operating methods thereof, or operating methods of an electronic system including the same.

According to an example embodiment, an operating method of an electronic device which includes a device controller, a volatile memory device, a non-volatile memory device, and a recovery device includes backing up, by the recovery device, copy data of user data stored in the volatile memory device to the non-volatile memory device based on health information of the volatile memory device, providing, by the device controller, a read request for at least a portion of the user data to the volatile memory device, performing, by the volatile memory device, an error verification operation based on the read request, storing, by the volatile memory device, first metadata indicating that an uncorrectable error has occurred, based on a result of the error verification operation, restoring, by the recovery device, the user data with the copy data, based on a result of monitoring the first metadata of the volatile memory device, and providing, by the volatile memory device, the at least a portion of the user data to the device controller.

According to an example embodiment, an operating method of an electronic system which includes a host device and an electronic device configured to communicate with the host device, the electronic device including a device controller, a volatile memory device, a non-volatile memory device, and a recovery device includes backing up, by the recovery device, copy data of user data stored in the volatile memory device to the non-volatile memory device based on health information of the volatile memory device, transmitting, by the host device, a read command for at least a portion of the user data to the electronic device, providing, by the device controller, a read request for the at least a portion of the user data to the volatile memory device based on the read command, performing, by the volatile memory device, an error verification operation based on the read request, storing, by the volatile memory device, metadata indicating that an uncorrectable error has occurred, based on a result of the error verification operation, restoring, by the recovery device, the user data with the copy data, based on a result of monitoring the metadata of the volatile memory device, providing, by the volatile memory device, the at least a portion of the user data to the device controller, and transmitting, by the volatile memory device, the at least a portion of the user data to the host device.

According to an example embodiment, an electronic device includes a device controller, a volatile memory device, a non-volatile memory device, and a recovery device. The recovery device is configured to back up copy data of user data stored in the volatile memory device to the non-volatile memory device based on health information of the volatile memory device. The device controller is configured to provide a read request for at least a portion of the user data to the volatile memory device. The volatile memory device is configured to perform an error verification operation based on the read request and store metadata indicating that an uncorrectable error has occurred, based on a result of the error verification operation. The non-volatile memory device is configured to store the copy data, the recovery device is configured to restore the user data with the copy data based on a result of monitoring the metadata of the volatile memory device, and the volatile memory device is configured to provide the at least a portion of the user data to the device controller. According to an example embodiment, an electronic system includes a host device and An electronic device, which includes a device controller, a volatile memory device, a non-volatile memory device, and a recovery device. The recovery device is configured to back up copy data of user data stored in the volatile memory device to the non-volatile memory device based on health information of the volatile memory device. The device controller is configured to provide a read request for at least a portion of the user data to the volatile memory device. The volatile memory device is configured to perform an error verification operation based on the read request and store metadata indicating that an uncorrectable error has occurred, based on a result of the error verification operation. The non-volatile memory device is configured to store the copy data, the recovery device is configured to restore the user data with the copy data based on a result of monitoring the metadata of the volatile memory device, and the volatile memory device is configured to provide the at least a portion of the user data to the device controller.

### BRIEF DESCRIPTION OF THE FIGURES

The above and other objects and features of the present disclosure will become apparent by describing in detail some example embodiments thereof with reference to the accompanying drawings.

FIG. 1 is a block diagram of an electronic system according to an example embodiment of the present disclosure.

FIG. 2 is a block diagram of an electronic device according to an example embodiment of the present disclosure.

FIG. 3 is a flowchart describing an operating method of an electronic device according to an example embodiment of the present disclosure.

FIG. 4 is a flowchart describing an operating method of an electronic device according to an example embodiment of the present disclosure.

FIG. 5 is a block diagram describing a back-up operation and a restore operation of an electronic device according to an example embodiment of the present disclosure.

FIG. 6 is a diagram describing an operating method of a recovery device according to some embodiments of the present disclosure.

FIG. 7 is a diagram describing an electronic device according to an example embodiment of the present disclosure.

FIG. 8 is a diagram describing an electronic device according to an example embodiment of the present disclosure.

FIG. 9 is a flowchart describing an operating method of a recovery device according to an example embodiment of the present disclosure.

FIG. 10 is a flowchart describing an operating method of an electronic device according to an example embodiment of the present disclosure.

### DETAILED DESCRIPTION

Below, some example embodiments of the present disclosure will be described in detail and clearly to such an extent that one skilled in the art carries out example embodiments of the present disclosure easily.

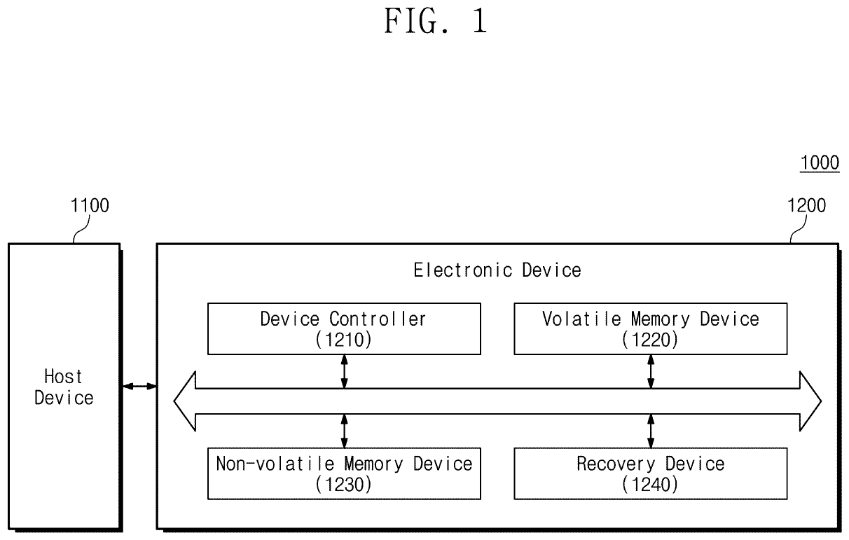

FIG. 1 is a block diagram of an electronic system according to an example embodiment of the present disclosure. Referring to FIG. 1, an electronic system 1000 may include a host device 1100 and an electronic device 1200. In some example embodiments, the electronic system 1000 may be a computing system configured to process or store a variety of information. For example, the electronic system 1000 may be included in user devices such as a personal computer, a laptop computer, a server, a media player, and a digital camera or automotive devices such as a navigation system, a black box, and an automotive electronic device/part. In some example embodiments, the electronic system 1000 may be a mobile system such as a mobile phone, a smartphone, a tablet personal computer (PC), a wearable device, a health care device, or an Internet of things (IoT) device.

The host device 1100 may control all the operations of the electronic system 1000. In an example embodiment, the host device 1100 may be one of various processors such as a central processing unit (CPU), a graphics processing unit (GPU), a neural processing unit (NPU), or a data processing unit (DPU). In an example embodiment, the host device 1100 may include a single core processor or a multi-core processor.

The host device 1100 may store data in the electronic device 1200 or may read data stored in the electronic device 1200. The host device 1100 may provide a write command to the electronic device 1200 to store data in the electronic device 1200 or may provide a read command to the electronic device 1200 to read data stored in the electronic device 1200.

The electronic device 1200 may be used as a main memory or a system memory of the electronic system 1000. The electronic device 1200 may include a device controller 1210, a volatile memory device 1220, a non-volatile memory device 1230, and a recovery device 1240.

The device controller 1210, the volatile memory device 1220, the non-volatile memory device 1230, and the recovery device 1240 may be configured to share the same interface. For example, the device controller 1210, the volatile memory device 1220, the non-volatile memory device 1230, and the recovery device 1240 may be configured to communicate through a compute express link (CXL) interface. In some example embodiments, the CXL interface may refer to a low-latency and high-bandwidth link which supports coherency, memory access, and dynamic protocol muxing of I/O protocols such that various connections between accelerators, memory devices, or various electronic devices are possible. However, the CXL interface is provided only for better understanding and is not intended to limit the scope of the present disclosure.

The device controller 1210 may control all the operations of the electronic device 1200. For example, to control the operations of the volatile memory device 1220 and the non-volatile memory device 1230, the device controller 1210 may provide requests to the volatile memory device 1220 and the non-volatile memory device 1230. In some example embodiments, to store data in the volatile memory device 1220 or the non-volatile memory device 1230, the device controller 1210 may provide the volatile memory device 1220 or the non-volatile memory device 1230 with a write request indicating the write operation of data. Also, to transmit data stored in the volatile memory device 1220 to the host device 1100, the device controller 1210 may provide the volatile memory device 1220 with a read request indicating the read operation of data.

The volatile memory device 1220 may be implemented with a volatile memory device, which loses data stored therein when a power is turned off, such as a dynamic random access memory (DRAM) or a static random access memory (SRAM).

The volatile memory device 1220 may store data and may provide the stored data to the device controller 1210. For example, the volatile memory device 1220 may receive the write request indicating the write operation of data from the device controller 1210 and may store the data in response to the write request. Also, the volatile memory device 1220 may receive the read request indicating the read operation of data from the device controller 1210 and may provide the stored data to the device controller 1210 in response to the read request.

An error may occur in the data which the volatile memory device 1220 stores. When the data including the error are provided to the host device 1100, a critical system issue may occur in the electronic system 1000. Accordingly, the electronic device 1200 (e.g., the volatile memory device 1220 of the electronic device 1200) may perform an error verification operation of data to be provided to the host device 1100 by using an ECC engine. The electronic device 1200 (e.g., the volatile memory device 1220) may perform the error verification operation of data to determine whether an error has occurred in the data.

The volatile memory device 1220 may perform the error correction operation by using the ECC engine but may fail to correct partial data in which the error has occurred. That is, a portion of data stored in the volatile memory device 1220 may include an uncorrectable error. When the volatile memory device 1220 fails to correct the error of data, the device controller 1210 may return a read fail to the host device 1100. The read fail may cause a delay or an error of an electronic system.

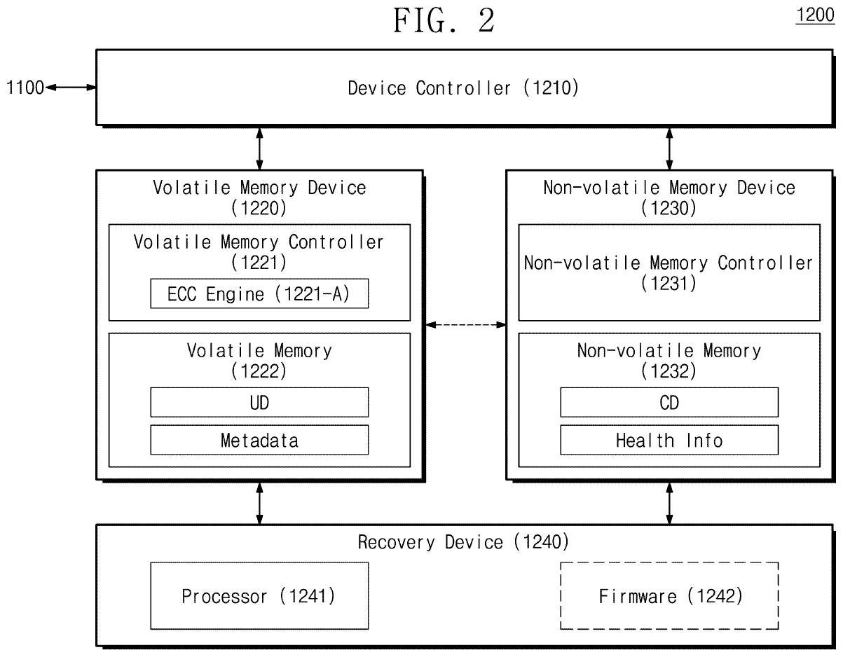

To recover the uncorrectable error, the volatile memory device 1220 may store copy data in the non-volatile memory device 1230. For example, the volatile memory device 1220 may receive a back-up request from the recovery device 1240 and may provide copy data of stored user data UD to the non-volatile memory device 1230 in response to the back-up request. The volatile memory device 1220 will be described in detail with reference to FIG. 2.

The non-volatile memory device 1230 may be implemented with a non-volatile memory device, which retains data stored therein even though a power is turned off, such as a NAND (not and)-based flash memory device, a NOR (not or)-based flash memory device, a phase-change RAM (PRAM), a magnetic RAM (MRAM), a resistive RAM (RRAM), etc.

The non-volatile memory device 1230 may store data. For example, the non-volatile memory device 1230 may receive the write request from the device controller 1210 and may store data in response to the write request.

The non-volatile memory device 1230 may provide the stored copy data to the volatile memory device 1220. For example, the non-volatile memory device 1230 may receive a recovery request from the recovery device 1240 and may provide the stored copy data to the volatile memory device 1220 in response to the recovery request. The volatile memory device 1220 may replace user data, in which an uncorrectable error has occurred, with the copy data received from the non-volatile memory device 1230.

The non-volatile memory device 1230 will be described in detail with reference to FIG. 2.

The recovery device 1240 may back up copy data of user data to the non-volatile memory device 1230. In some example embodiments, the recovery device 1240 may monitor the volatile memory device 1220 and may determine whether there is a need to back up user data stored in any sector among sectors of the volatile memory device 1220. The recovery device 1240 may back up copy data of user data stored in the backup-required sector (or the backup-desired sector) among the sectors of the volatile memory device 1220 to the non-volatile memory device 1230.

The recovery device 1240 may restore the user data with the copy data. For example, when an uncorrectable error has occurred in the user data stored in the volatile memory device 1220, the recovery device 1240 may restore the user data with the copy data stored in the non-volatile memory device 1230.

The recovery device 1240 may improve the reliability of data by backing up the copy data to the non-volatile memory device 1230 before an uncorrectable error has occurred in the user data stored in the volatile memory device 1220.

The recovery device 1240 will be described in detail with reference to FIG. 2.

FIG. 2 is a block diagram of an electronic device according to an example embodiment of the present disclosure. Referring to FIG. 2, the electronic device 1200 may include the device controller 1210, the volatile memory device 1220, the non-volatile memory device 1230, and the recovery device 1240.

The device controller 1210 may control all the operations of the electronic device 1200. For example, under control of the host device 1100, the device controller 1210 may store data (e.g., the user data UD) in the volatile memory device 1220 or the non-volatile memory device 1230 or may transmit data (e.g., the user data UD) stored in the volatile memory device 1220 to the host device 1100.

The device controller 1210 may receive the read command from the host device 1100. For example, the device controller 1210 may receive the read command indicating the read operation of the user data UD stored in the volatile memory device 1220. The device controller 1210 may provide the volatile memory device 1220 with the read request indicating the read operation of the user data UD in response to the read command. The device controller 1210 may transmit the user data UD received from the volatile memory device 1220 to the host device 1100.

The volatile memory device 1220 may exchange data (e.g., copy data CD or health information) with the non-volatile memory device 1230. For example, the volatile memory device 1220 may exchange data (e.g., the copy data CD or the health information) with the non-volatile memory device 1230 through the device controller 1210. However, the exchange of data through the device controller 1210 is provided only for better understanding and is not intended to limit the scope of the present disclosure.

The volatile memory device 1220 may include a volatile memory controller 1221 and a volatile memory 1222.

The volatile memory controller 1221 may control all the operations of the volatile memory device 1220. For example, in response to requests received from the device controller 1210 and the recovery device 1240, the volatile memory controller 1221 may store data (e.g., the user data UD) in the volatile memory 1222 or may provide stored data (e.g., the user data UD, the copy data CD, or the health information) to any other devices (e.g., the device controller 1210 or the non-volatile memory device 1230).

In some example embodiments, the volatile memory controller 1221 may operate in response to the back-up request received from the recovery device 1240. For example, the volatile memory controller 1221 may generate the same copy data CD as the user data UD indicated by the back-up request and may provide the copy data CD to the non-volatile memory device 1230.

In some example embodiments, the volatile memory controller 1221 may replace the user data UD, in which an error (e.g., an uncorrectable error has occurred), with the copy data CD received from the non-volatile memory device 1230 and may provide the replaced user data UD to the device controller 1210.

In some example embodiments, the volatile memory controller 1221 may store metadata in the volatile memory 1222. For example, the volatile memory controller 1221 may store metadata associated with an operation of the volatile memory device 1220 in the volatile memory 1222. The metadata may include information for managing and accessing data stored in the volatile memory 1222. For example, the metadata may include the following information: addresses of data stored in the volatile memory 1222, whether sectors of the volatile memory 1222 are used, the authority to access, an access time or a delay time associated with the volatile memory 1222, information about error detection and error correction, and/or temperature information.

In some example embodiments, the volatile memory controller 1221 may store metadata indicating a result of performing the error verification operation of the user data UD in the volatile memory 1222.

In some example embodiments, the volatile memory controller 1221 may provide the metadata to the non-volatile memory device 1230 under control of the recovery device 1240. In other words, the recovery device 1240 may update the health information stored in a non-volatile memory 1232 with the metadata stored in the volatile memory 1222.

For example, because the metadata stored in the volatile memory 1222 are lost when the power supply to the volatile memory device 1220 is blocked, the recovery device 1240 may store (or back up) partial information (e.g., the number of times of occurrence of an error or temperature information) of the metadata, which is used to determine the necessity or need of the back-up operation, in the non-volatile memory 1232 as the health information.

The volatile memory controller 1221 may include an ECC engine 1221-A. The ECC engine 1221-A may perform the error verification operation and the error correction operation of data (e.g., the user data UD) stored in the volatile memory device 1220. For example, the ECC engine 1221-A may generate parity bits for the user data UD to be stored in the volatile memory device 1220, and the parity bits thus generated may be stored in the volatile memory 1222 together with the user data UD.

When the user data UD are read from the volatile memory 1222, the ECC engine 1221-A may perform the error verification operation and the error correction operation of the user data UD by using the parity bits read from the volatile memory 1222 together with the user data UD thus read.

In some example embodiments, the ECC engine 1221-A may determine that an error of the user data UD is an uncorrectable error. For example, when the number of bits of the error occurred in the user data UD exceeds the number of parity bits or the parity bits are damaged, the ECC engine 1221-A (or the volatile memory controller 1221) may determine that the error of the user data UD is an uncorrectable error.

In some example embodiments, the ECC engine 1221-A may determine that an error of the user data UD is a correctable error. For example, when the number of bits of the error occurred in the user data UD is equal to or smaller than the number of parity bits, the ECC engine 1221-A (or the volatile memory controller 1221) may determine that the error of the user data UD is a correctable error. Accordingly, the ECC engine 1221-A may correct the error of the user data UD, and the volatile memory device 1220 may provide the user data UD to the device controller 1210.

The volatile memory 1222 may store data. For example, the volatile memory 1222 may store the user data UD received from the device controller 1210, the metadata, etc.

The volatile memory 1222 may include at least one or more sectors for storing data. Each of the sectors may be referred to as a “row”, “page”, “column”, or “memory block” of the volatile memory 1222.

An error (e.g., a correctable error or an uncorrectable error) may occur in the data stored in the volatile memory 1222. For example, an error (e.g., a correctable error or an uncorrectable error) may occur in the data stored in the volatile memory 1222 due to various causes such as sudden power-off (SPO), noise or electromagnetic interference, temperature change, refresh fail, degradation of a memory cell, manufacturing defect, an error of the volatile memory controller 1221, and/or reduction of endurance.

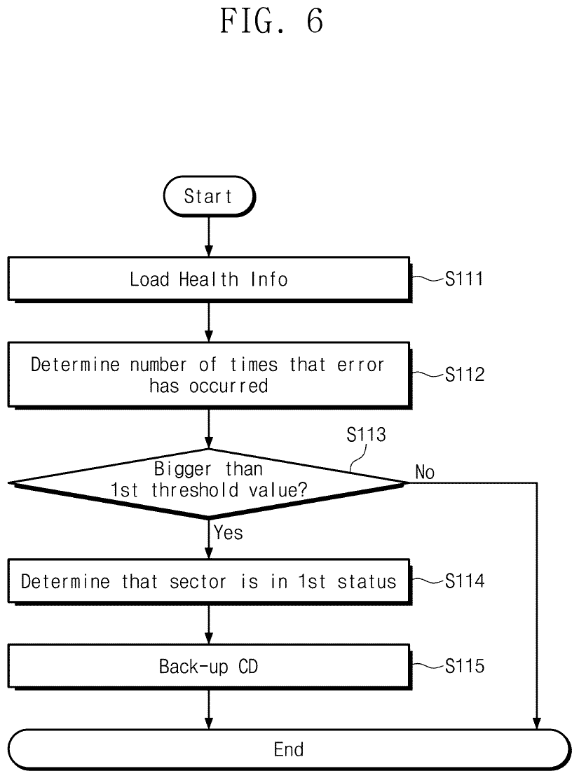

In some example embodiments, to predict a sector, in which the probability that an error is capable of occurring in the stored data is higher than a reference value, from among the plurality of sectors of the volatile memory 1222, and to back up a sector in which an uncorrectable error is capable of occurring, the sectors of the volatile memory 1222 may be classified into a plurality of statuses (e.g., first to third statuses) by the recovery device 1240. For example, the first status may indicate a status in which the backup of stored data is desired or required, the second status may indicate a status in which the reliability of stored data is lower than a threshold reliability, and the third status may indicate a normal status. A criterion which is used to classify the sectors of the volatile memory 1222 into a plurality of statuses (e.g., the first to third statuses) will be described in detail with reference to FIGS. 6 to 9.

The non-volatile memory device 1230 may exchange data (e.g., the copy data CD or the metadata) with the volatile memory device 1220. For example, the non-volatile memory device 1230 may exchange data (e.g., the copy data CD or the metadata) with the volatile memory device 1220 through the device controller 1210. However, the exchange of data through the device controller 1210 is provided only for better understanding and is not intended to limit the scope of the present disclosure.

The non-volatile memory device 1230 may include a non-volatile memory controller 1231 and the non-volatile memory 1232.

The non-volatile memory controller 1231 may control all the operations of the non-volatile memory device 1230. For example, in response to requests received from the device controller 1210 and the recovery device 1240, the non-volatile memory controller 1231 may store data (e.g., the user data UD, the copy data CD, or the health information) in the non-volatile memory 1232 or may provide stored data (e.g., the user data UD, the copy data CD, or the health information) to any other devices (e.g., the device controller 1210 or the volatile memory device 1220).

In some example embodiments, the non-volatile memory controller 1231 may provide the copy data CD to the volatile memory device 1220 in response to the recovery request received from the recovery device 1240.

The non-volatile memory 1232 may store data. For example, the non-volatile memory 1232 may store data received from the device controller 1210, or the copy data CD or the health information (including a portion of the metadata) received from the volatile memory device 1220.

The recovery device 1240 may control the back-up operation and a restore operation of the electronic device 1200. For example, based on the health information stored from the volatile memory device 1220 to the non-volatile memory device 1230, the recovery device 1240 may determine whether there is a need to back up the copy data CD of the user data UD stored in the volatile memory device 1220. The recovery device 1240 may provide the back-up request to the volatile memory device 1220 based on determining that there is a need to back up.

The recovery device 1240 may monitor the volatile memory device 1220 (e.g., may refer to the metadata indicating that an error has occurred) and may determine whether there is a need to restore the user data UD with the copy data CD stored in the non-volatile memory device 1230. In some example embodiments, the volatile memory device 1220 may store the metadata indicating that an uncorrectable error has occurred and may determine that there is a need to restore the user data UD with the copy data CD stored in the non-volatile memory device 1230 based on the metadata. The recovery device 1240 may provide the recovery request to the non-volatile memory device 1230 based on determining that there is a need to restore the user data UD with the copy data CD.

The recovery device 1240 may include a processor 1241 and firmware 1242. The processor 1241 may implement the operations or functions of the recovery device 1240 by executing instructions stored in or loaded to the firmware 1242. The processor 1241 may be implemented with various hardware devices such as an integrated circuit (IC), an application specific IC (ASIC), a field programmable gate array (FPGA), and/or a complex programmable logic device (CPLD). Also, the firmware 1242 may be driven on the processor 1241 and may store or load the instructions for implementing the operations or functions of the recovery device 1240.

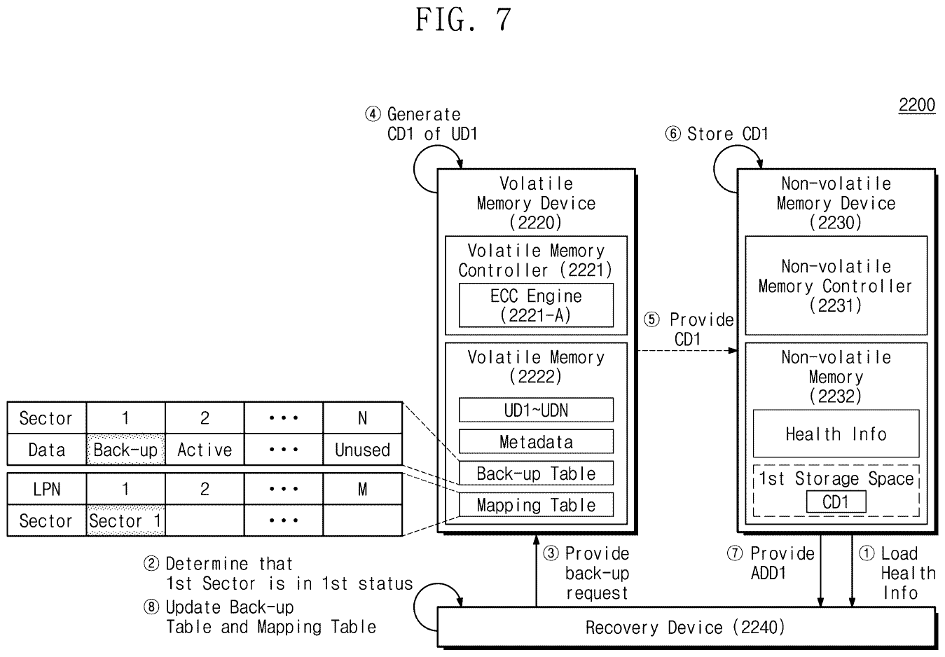

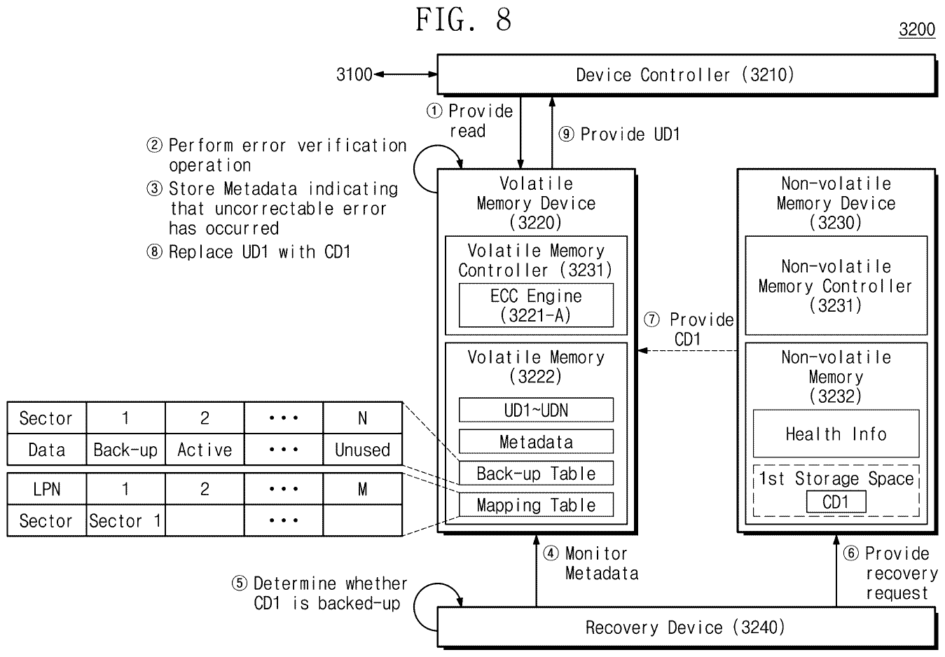

The recovery device 1240 will be described in detail with reference to FIGS. 7 and 8.

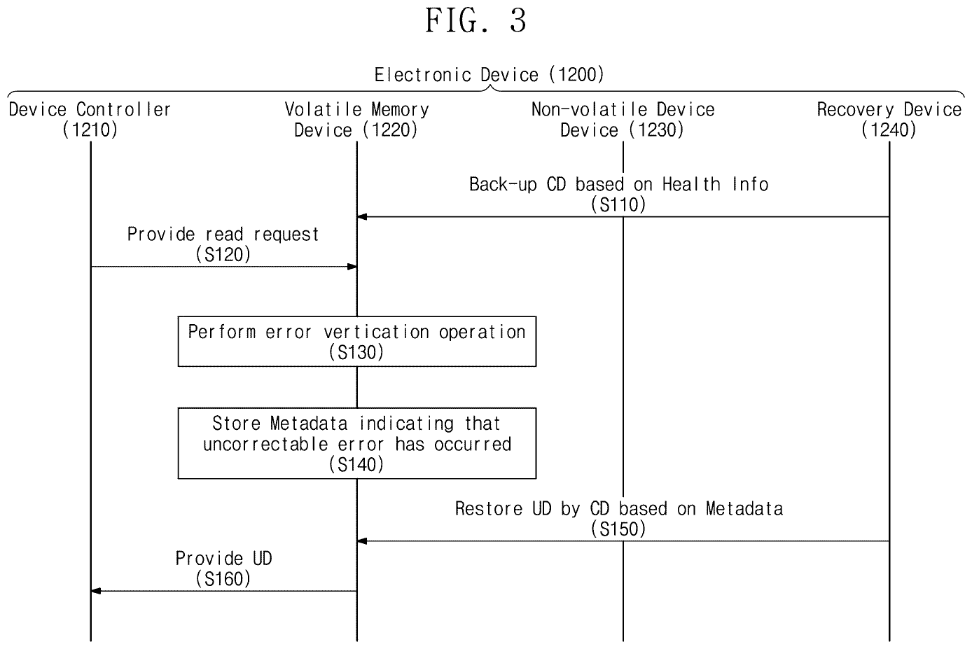

FIG. 3 is a flowchart describing an operating method of an electronic device according to an example embodiment of the present disclosure. Referring to FIG. 3, the electronic device 1200 may include the device controller 1210, the volatile memory device 1220, the non-volatile memory device 1230, and the recovery device 1240.

In operation S110, the recovery device 1240 may back up the copy data CD of the user data UD based on the health information. For example, based on the health information, the recovery device 1240 may back up the copy data CD of the user data UD stored in the volatile memory device 1220.

In some example embodiments, the recovery device 1240 may determine that there is a need to back up the user data UD stored in the volatile memory device 1220, based on the health information, and may provide the back-up request of the copy data CD of the user data UD to the volatile memory device 1220. The volatile memory device 1220 may provide the copy data CD to the non-volatile memory device 1230 in response to the back-up request.

The health information may include error information and/or temperature information among the metadata of the volatile memory device 1220.

How to provide the back-up request to the volatile memory device 1220 based on the health information will be described in detail with reference to FIG. 6.

In operation S120, the device controller 1210 may provide the volatile memory device 1220 with the read request for at least a portion of the user data UD. For example, the device controller 1210 may receive the read command for at least a portion of the user data UD from the host device 1100 of FIG. 2 and may provide the read request for the at least a portion of the user data UD to the volatile memory device 1220 based on the read command.

In operation S130, the volatile memory device 1220 may perform the error verification operation based on the read request. For example, based on the read request, the volatile memory device 1220 may load the stored user data UD and may perform the error verification operation of the user data UD by using an ECC engine. The volatile memory device 1220 may perform the error verification operation of the user data UD to check whether an error has occurred in the user data UD, and when an error exists, the volatile memory device 1220 may perform the error correction operation.

In operation S140, the volatile memory device 1220 may store the metadata indicating that an uncorrectable error has occurred, based on a result of the error verification operation. For example, the volatile memory device 1220 may perform the error verification operation of the user data UD, may determine that an error has occurred in the user data UD, and may fail in the error correction operation.

The volatile memory device 1220 may determine that an uncorrectable error has occurred, based on failing in the error correction operation. For example, when the number of bits of the error occurred in the user data UD exceeds the number of parity bits or the parity bits are damaged, the volatile memory device 1220 may determine that the error of the user data UD is an uncorrectable error. The volatile memory device 1220 may store the metadata indicating that an uncorrectable error has occurred.

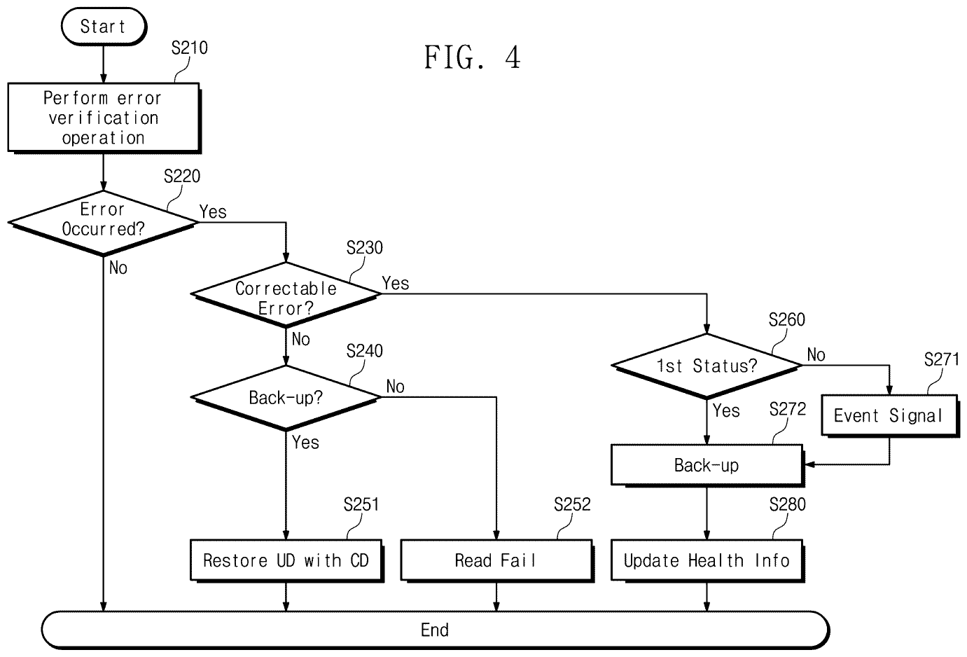

The case where an error is absent from the user data UD or the case where a correctable error has occurred will be described in detail with reference to FIG. 4.

In operation S150, the recovery device 1240 may restore the user data UD with the copy data CD based on a result of monitoring the metadata of the volatile memory device 1220. In some example embodiments, the recovery device 1240 may monitor the metadata of the volatile memory device 1220 and may determine that there is a need to restore the user data UD, based on a result of monitoring that the volatile memory device 1220 stores the metadata indicating that an uncorrectable error has occurred. The recovery device 1240 may provide the recovery request to the non-volatile memory device 1230 based on determining that there is a need to restore the user data UD.

The non-volatile memory device 1230 may provide the stored copy data CD to the volatile memory device 1220 in response to the recovery request.

In operation S160, the volatile memory device 1220 may provide at least a portion of the user data UD to the device controller 1210. For example, the volatile memory device 1220 may replace the user data UD, in which the error has occurred, with the copy data CD received from the non-volatile memory device 1230 and may provide at least a portion of the replaced user data UD to the device controller 1210.

FIG. 4 is a flowchart describing an operating method of an electronic device according to an example embodiment of the present disclosure. Referring to FIGS. 2 and 4, when the electronic device 1200 performs the error verification operation of the user data UD, the electronic device 1200 may operate based on a result of the error verification operation.

In operation S210, the electronic device 1200 may perform the error verification operation of the user data UD.

In operation S220, the electronic device 1200 may determine whether an error (e.g., a correctable error or an uncorrectable error) has occurred in the user data UD.

When it is determined that the error has occurred in the user data UD, in operation S230, the electronic device 1200 may determine whether the error of the user data UD is a correctable error.

When it is determined that the error of the user data UD is not a correctable error (i.e., is an uncorrectable error), in operation S240, the electronic device 1200 may determine whether the copy data CD of the user data UD are stored. How the electronic device 1200 determines whether the copy data CD of the user data UD are backed up will be described in detail with reference to FIG. 7.

When it is determined that the copy data CD of the user data UD are backed up, in operation S251, the electronic device 1200 may replace the user data UD with the copy data CD. For example, the electronic device 1200 may delete the user data UD including the uncorrectable error and may store the copy data CD as the user data UD. After the electronic device 1200 replaces the user data UD with the copy data CD, the electronic device 1200 may transmit the replaced user data UD to the host device 1100.

When it is determined that the copy data CD of the user data UD are not backed up, in operation S252, the electronic device 1200 may issue or send the read fail to the host device 1100. The read fail may cause a delay or an error of an electronic system.

When it is determined that the error of the user data UD is a correctable error, in operation S260, the electronic device 1200 may determine whether a sector where the user data UD are stored is in the first status. The first status may indicate a status in which the back-up operation of the stored data is desired or required. A criterion for determining whether the sector is in the first status will be described in detail with reference to FIG. 6.

When it is determined that the sector where the user data UD are stored is in the second status (e.g., when it is determined that the sector where the user data UD are stored is in the second status in which the reliability of the stored data is lower than the threshold reliability), in operation S271, the electronic device 1200 may provide an event signal to the host device 1100. For example, the electronic device 1200 may provide the host device 1100 with the event signal indicating that the sector where the user data UD are stored stores data whose reliability is lower than the threshold reliability.

In some example embodiments, the host device 1100 may guide the check or exchange of the volatile memory device 1220 to the user of the electronic system 1000. Also, based on determining that the sector where the user data UD are stored is in the second status, the electronic device 1200 may not store data (e.g., the user data UD or the metadata) in the sector.

In some example embodiments, while or before the electronic device 1200 provides the event signal to the host device 1100, the electronic device 1200 may correct the correctable error and may provide the user data UD to the host device 1100.

When it is determined that the sector where the user data UD are stored is in the first status or after operation S271 in which the electronic device 1200 provides the event signal to the host device 1100, the electronic device 1200 may perform the back-up operation of the sector where the user data UD are stored. For example, the electronic device 1200 may back up copy data CD of the user data UD stored in the sector that is determined as being in the first status from among the plurality of sectors of the volatile memory device 1220.

For example, the electronic device 1200 may generate the same copy data CD as the user data UD stored in the sector that is determined as being in the first status, and may store the generated copy data CD in the non-volatile memory device 1230.

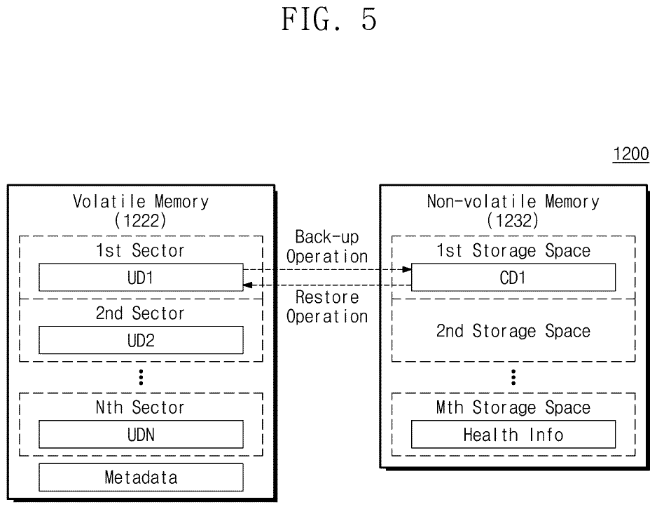

In operation S280, the electronic device 1200 may update the health information to indicate that a correctable error has occurred. For example, the electronic device 1200 may store, as the health information, the number of times that a correctable error or an uncorrectable error has occurred in the sector where the user data UD are stored and may update the health information based on a result of operation S230, that is, based on determining that the correctable error has occurred. To prevent or reduce the loss of health information storing the number of times that errors have occurred in sectors of the volatile memory device 1220, the electronic device 1200 may store the health information in the non-volatile memory device 1230. FIG. 5 is a block diagram describing a back-up operation and a restore operation of an electronic device according to an example embodiment of the present disclosure. Referring to FIG. 5, the electronic device 1200 may include the volatile memory 1222 and the non-volatile memory 1232.

The volatile memory 1222 may include first to N-th sectors. “N” is an arbitrary natural number. Each of the first to N-th sectors may store the user data UD. For example, the first to N-th sectors may store first to N-th user data UD1 to UDN, respectively. However, FIG. 5 is provided only for better understanding and is not intended to limit the scope of the present disclosure. Some of the first to N-th sectors may store data (e.g., health information) different from user data or may not store data.

The non-volatile memory 1232 may include first to M-th storage spaces. “M” is an arbitrary natural number. Each storage space may be referred to as a “page”, “block”, “plane”, “die”, or “page pool” of the non-volatile memory 1232. The non-volatile memory 1232 may allocate some of the first to M-th storage spaces to store copy data.

The back-up operation may refer to an operation of providing copy data of user data stored in the volatile memory 1222 to the non-volatile memory 1232. For example, first copy data CD1 which is the same as the first user data UD1 stored in the first sector may be generated, and the first copy data CD1 may be provided to the non-volatile memory 1232.

The non-volatile memory 1232 may allocate a first storage space to store the first copy data CD1 and may store the first copy data CD1 in the first storage space.

Because the back-up operation for all the first to N-th sectors of the volatile memory 1222 is not desired or required, copy data of all the first to N-th user data UD1 to UDN may not be stored in the non-volatile memory 1232.

As illustrated in FIG. 5, the non-volatile memory 1232 may store the health information in some of the first to M-th storage spaces. As the non-volatile memory 1232 stores the health information including a portion (e.g., error information or temperature information) of the metadata of the volatile memory device 1220, the electronic device 1200 may cumulatively store the health information even after the power supply is blocked.

The restore operation may refer to an operation of providing the copy data stored in the non-volatile memory 1232 to the volatile memory 1222. For example, when an uncorrectable error is detected from the first user data UD1, the non-volatile memory 1232 may provide the first copy data CD1, which is the same as the first user data UD1, to the volatile memory 1222 based on the back-up request.

The first user data UD1 stored in the volatile memory 1222 may be replaced with the first copy data CD1. Accordingly, the electronic device 1200 may read the user data UD, which belong to the replaced first user data UD1, from the volatile memory 1222.

FIG. 6 is a diagram describing an operating method of a recovery device according to an example embodiment of the present disclosure. Referring to FIGS. 2 and 6, based on the health information, the recovery device 1240 may back up the copy data CD of the user data UD stored in the volatile memory device 1220 to the non-volatile memory device 1230. Below, operation S110 of FIG. 3 will be described in detail.

In operation S111, the recovery device 1240 may load the health information. For example, the recovery device 1240 may load the health information stored in the non-volatile memory device 1230 and may refer to the loaded health information.

The health information may include a portion of metadata of a volatile memory device. For example, the health information may include information associated with sectors, each of which stores data where an error (e.g., a correctable error or an uncorrectable error) has occurred. In some example embodiments, the health information may include the following information: the number of times of occurrence of an error of any sector among a plurality of sectors, a time when an error has occurred, and a detailed bit position of data, at which an error has occurred.

As another example, the health information may include temperature information of the volatile memory device 1220. For example, the health information may include information about a time-series temperature change of the volatile memory device 1220.

In operation S112, the recovery device 1240 may determine the number of times that an error (e.g., a correctable error or an uncorrectable error) has occurred in the first sector, based on the health information. However, although not illustrated in FIG. 6, as another example embodiment, the recovery device 1240 may determine the number of times that a temperature of the volatile memory device 1220 corresponding to the first sector exceeds a threshold temperature, based on the health information.

In operation S113, the recovery device 1240 may determine whether the number of times that an error (e.g., a correctable error or an uncorrectable error) has occurred or the number of times that a temperature of the volatile memory device 1220 corresponding to the first sector exceeds the threshold temperature is bigger than a first threshold value.

In operation S114, the recovery device 1240 may determine that the first sector is in the first status, based on determining that the number of times is bigger than the first threshold value. That is, the recovery device 1240 may determine that there is a need to back up the copy data CD of the user data UD stored in the first sector (or that the back-up operation of the first sector is desired or required).

In operation S115, the recovery device 1240 may back up the copy data CD of the user data UD. For example, the recovery device 1240 may provide the back-up request of the copy data CD of the user data UD to the volatile memory device 1220. How the recovery device 1240 backs up the copy data CD of the user data UD will be described in detail with reference to FIG. 7.

FIG. 7 is a diagram describing an electronic device according to an example embodiment of the present disclosure. Referring to FIG. 7, an electronic device 2200 may include a volatile memory device 2220, a non-volatile memory device 2230, and a recovery device 2240. The electronic device 2200 is partially similar to the electronic device 1200 of FIG. 2, and thus, duplicative description will be omitted to avoid redundancy.

A volatile memory 2222 may include a back-up table and a mapping table. The back-up table and the mapping table may be a portion of metadata stored in the volatile memory 2222 or may be stored in the volatile memory 2222 independently of the metadata.

The back-up table may indicate whether the first to N-th sectors in the volatile memory 2222 store the user data UD1 to UDN, respectively, and whether copy data of the user data UD1 to UDN are backed up. For example, when the back-up operation of the first sector is performed (e.g., when the first copy data CD1 of the first user data UD1 stored in the first sector are backed up), the back-up table may indicate that the first sector is “backed up”. Also, when the second sector stores the second user data UD2 but the back-up operation of the second sector is not performed (e.g., when the copy data of the second user data UD2 are not backed up), the back-up table may indicate that the second sector is “active”. Finally, when the N-th sector does not store N-th user data UDN, the back-up table may indicate that the N-th sector is “unselected”.

The mapping table may indicate a mapping relationship between the first to M-th storage spaces of a non-volatile memory 2232 and the first to N-th sectors of the volatile memory 2222, respectively. For example, when the first storage space of the non-volatile memory 2232 is allocated to the first sector of the volatile memory 2222 (e.g., when the first storage space stores the first copy data CD1 of the first user data UD1 stored in the first sector), mapping data may map the first storage space to the first sector. In FIG. 6, the first to M-th storage spaces are illustrated by using logical page numbers (LPN), but this is provided only for better understanding and is not intended to limit the scope of the present disclosure.

In a first operation \textcircled{1}, the recovery device 2240 may load the health information. For example, the recovery device 1240 may load the health information stored in the non-volatile memory device 2230.

In a second operation \textcircled{2}, the recovery device 2240 may determine that the first sector is in the first status (e.g., a status in which the back-up operation is desired or required). For example, the recovery device 2240 may determine that the first sector is in the first status, based on the health information (including error information or temperature information). In some example embodiments, the recovery device 2240 may determine that the first sector is in the first status, based on determining that the number of times that an error (e.g., a correctable error or an uncorrectable error) has occurred in the first sector or the number of times that a temperature of the volatile memory device 2220 corresponding to the first sector exceeds the threshold temperature is bigger than the first threshold value.

In a third operation \textcircled{3}, the recovery device 2240 may provide the back-up request indicating the back-up operation of the first sector (e.g., an operation of backing up the first copy data CD1 of the first user data UD1 stored in the first sector) to the volatile memory device 2220.

In a fourth operation \textcircled{4}, the volatile memory device 2220 may generate the first copy data CD1 of the first user data UD1. For example, the volatile memory device 2220 may receive the back-up request from the recovery device 2240 and may generate the first copy data CD1, which is the same as the first user data UD1 stored in the first sector, based on the back-up request.

In a fifth operation \textcircled{5}, the volatile memory device 2220 may provide the first copy data CD1 to the non-volatile memory device 2230.

In a sixth operation \textcircled{6}, the non-volatile memory device 2230 may store the first copy data CD1. For example, the non-volatile memory device 2230 may store the first copy data CD1 in the first storage space allocated to the first sector.

In a seventh operation \textcircled{7}, the non-volatile memory device 2230 may provide a first address ADD1 of the first storage space to the recovery device 2240.

In an eighth operation \textcircled{8}, the recovery device 2240 may update the back-up table and the mapping table. For example, as shaded in the back-up table, the recovery device 2240 may update the back-up table to indicate that the back-up operation of the first sector is performed (e.g., that the first copy data CD1 of the first user data UD1 stored in the first sector are backed up). Also, as shaded in the mapping table, based on the first address ADD1, the recovery device 2240 may update the mapping table to indicate that the first storage space is allocated to the first sector.

As the recovery device 2240 updates the back-up table and the mapping table, when an uncorrectable error is detected from the volatile memory device 2220, the electronic device 2200 may quickly replace user data, in which the uncorrectable error has occurred, with copy data by referring to the back-up table and the mapping table and may transmit the replaced user data to the host device 1100 of FIG. 2 within a minimum delay time.

FIG. 8 is a diagram describing an electronic device according to an example embodiment of the present disclosure. Referring to FIG. 8, an electronic device 3200 may include a device controller 3210, a volatile memory device 3220, a non-volatile memory device 3230, and a recovery device 3240. The electronic device 3200 is partially similar to the electronic device 1200 of FIG. 2 and the electronic device 2200 of FIG. 7, and thus, duplicative description will be omitted to avoid redundancy.

In a first operation \textcircled{1}, the device controller 3210 may provide the read request to the volatile memory device 3220. For example, the device controller 3210 may receive the read command indicating the read operation of the first user data UD1 from a host device 3100 and may provide the read request for the first user data UD1 to the volatile memory device 3220 based on the read command.

In a second operation \textcircled{2}, the volatile memory device 3220 may perform the error verification operation of the first user data UD1. For example, the volatile memory device 3220 may receive the read request for the first user data UD1 from the device controller 3210 and may perform the error verification operation of the first user data UD1 based on the read request. The volatile memory device 3220 may perform the error verification operation to determine whether an error has occurred in the first user data UD1, and when it is determined that an error has occurred, the volatile memory device 3220 may perform the error correction operation.

In a third operation \textcircled{3}, the volatile memory device 3220 may store the metadata indicating that an uncorrectable error has occurred. For example, based on results of the error verification operation and the error correction operation, the volatile memory device 3220 (e.g., an ECC engine 3221-A) may determine that an uncorrectable error has occurred in the first user data UD1. The volatile memory device 3220 may store, in the volatile memory device 3220, the metadata indicating that an uncorrectable error has occurred.

In a fourth operation \textcircled{4}, the recovery device 3240 may monitor the volatile memory device 3220. For example, the recovery device 3240 may monitor the operation of the volatile memory device 3220 or may refer to the metadata stored in the volatile memory device 3220. The recovery device 3240 may monitor the metadata indicating that an uncorrectable error has occurred.

In a fifth operation \textcircled{5}, the recovery device 3240 may determine whether the first copy data CD1 has been backed up. For example, the recovery device 3240 may determine whether the back-up operation of the first sector storing the first user data UD1 has been performed (e.g., whether the first copy data CD1 of the first user data UD1 has been provided to the non-volatile memory device 2230), by referring to the back-up table.

Also, the recovery device 3240 may determine whether the first copy data CD1 of the first user data UD1 are stored in any storage space of the non-volatile memory device 3230, by referring to the mapping table. That is, the recovery device 3240 may determine that the first copy data CD1 of the first user data UD1 are stored in the first storage space of the non-volatile memory device 3230, by referring to the back-up table and the mapping table.

In a sixth operation \textcircled{6}, the recovery device 3240 may provide the recovery request to the non-volatile memory device 3230.

In a seventh operation \textcircled{7}, the non-volatile memory device 3230 may provide the first copy data CD1 to the volatile memory device 3220. In some example embodiments, the non-volatile memory device 3230 may provide the first copy data CD1 to the volatile memory device 3220 through the device controller 3210.

In an eighth operation \textcircled{8}, the volatile memory device 3220 may replace the first user data UD1 with the first copy data CD1. For example, the volatile memory device 3220 may replace the first user data UD1 including an uncorrectable error with the first copy data CD1 and may store the first copy data CD1 as the first user data UD1. Accordingly, the first user data UD1 stored in the volatile memory device 3220 may not include an uncorrectable error.

In a ninth operation \textcircled{9}, the volatile memory device 3220 may provide the first user data UD1 to the device controller 3210.

In some example embodiments, the volatile memory device 3220 may again perform the error verification operation of the first user data UD1. For example, before the volatile memory device 3220 provides the first user data UD1 to the device controller 3210, the volatile memory device 3220 may again perform the error verification operation of the first user data UD1.

When it is determined that a correctable error has occurred in the first user data UD1, the volatile memory device 3220 may perform the error correction operation of the first user data UD1 and may provide the corrected first user data UD1 to the device controller 3210. When it is determined that an uncorrectable error has occurred in the first user data UD1, the electronic device 3200 may repeat the first operation \textcircled{1} to the eighth operation \textcircled{8}.

The device controller 3210 may transmit the first user data UD1 to the host device 3100.

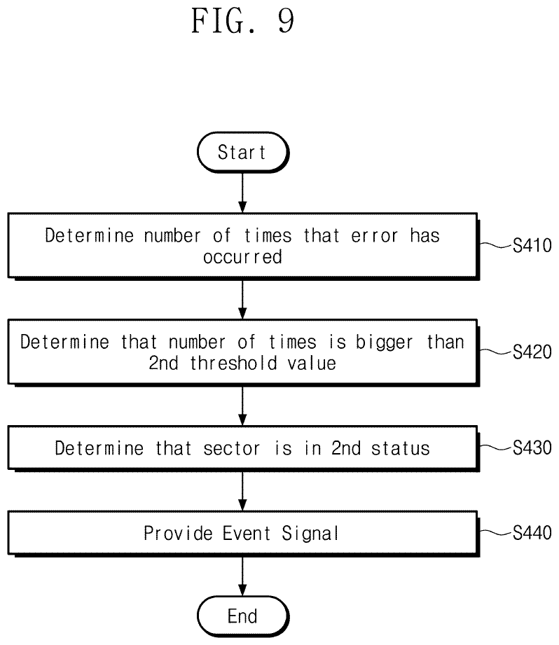

FIG. 9 is a flowchart describing an operating method of a recovery device according to an example embodiment of the present disclosure. Referring to FIGS. 2, 4, and 9, the recovery device 1240 may provide an event signal to the device controller 1210.

In operation S410, the recovery device 1240 may determine the number of times that an error (e.g., a correctable error or an uncorrectable error) has occurred in the first sector, based on the health information. For example, the recovery device 1240 may determine the number of times that an error has occurred in user data stored in a first sector among a plurality of sectors of the volatile memory device 1220, based on the health information.

As another example embodiment, the recovery device 1240 may determine the number of times that a temperature of the volatile memory device 1220 corresponding to the first sector exceeds the threshold temperature, based on the health information.

In operation S420, the recovery device 1240 may determine that the number of times (e.g., the number of times that an error has occurred in the first sector or the number of times that a temperature of the volatile memory device 1220 corresponding to the first sector exceeds the threshold temperature) exceeds a second threshold value. The second threshold value may be bigger than the first threshold value of FIG. 6.

In operation S430, the recovery device 1240 may determine that the first sector is in the second status. The second status may indicate a status in which the reliability of stored data is lower than the threshold reliability. For example, the recovery device 1240 may determine that the first sector is in the second status, based on determining that the number of times (e.g., the number of times that an error has occurred in the first sector or the number of times that a temperature of the volatile memory device 1220 corresponding to the first sector exceeds the threshold temperature) is bigger than the second threshold value, and the determination may be made based on the health information.

In operation S440, the recovery device 1240 may provide an event signal to the device controller 1210. For example, the recovery device 1240 may generate the event signal indicating the second status based on determining that the first sector is in the second status and may provide the generated event signal to the device controller 1210.

In some example embodiments, the device controller 1210 may receive the event signal from the recovery device 1240 and may transmit the received event signal to the host device 1100. In some example embodiments, the host device 1100 may receive the event signal from the electronic device 1200 (or the device controller 1210) and may notify the user of the electronic system 1000 to check or exchange the volatile memory device 1220, based on the received event signal. Also, based on determining that the first sector is in the second status, the electronic device 1200 may not store data (e.g., user data or metadata) in the first sector.

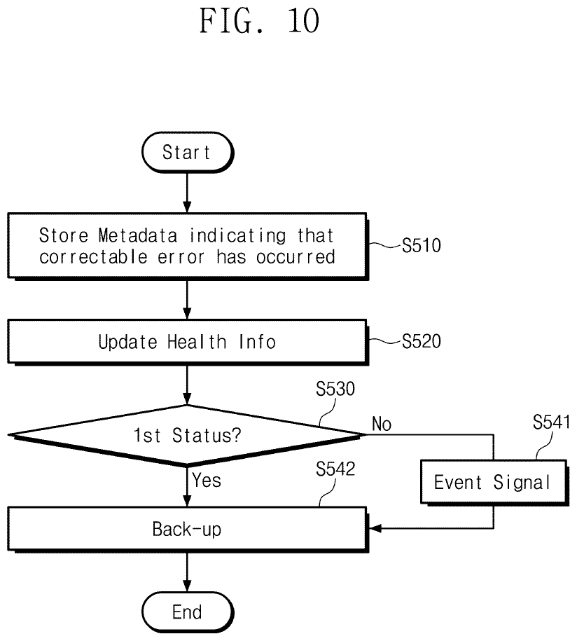

FIG. 10 is a flowchart describing an operating method of an electronic device according to an example embodiment of the present disclosure. Referring to FIGS. 2 and 10, the electronic device 1200 may update the health information when a correctable error has occurred (or is detected).

In operation S510, the electronic device 1200 (e.g., the volatile memory device 1220) may store metadata indicating that a correctable error has occurred. For example, the electronic device 1200 may perform the error verification operation of user data and may determine that an error has occurred in the user data, based on a result of the error verification operation. The electronic device 1200 may perform the error correction operation and may store the metadata indicating that a correctable error has occurred.

In operation S520, the electronic device 1200 (e.g., the recovery device 1240) may update the health information. For example, the recovery device 1240 may monitor the metadata indicating that a correctable error has occurred and may update the health information stored in the non-volatile memory device 1230 based on the metadata.

In operation S530, the electronic device 1200 (e.g., the recovery device 1240) may determine whether the first sector is in the first status, based on the health information. Operation S530 is similar operation S260 of FIG. 4, and thus, duplicative description will be omitted to avoid redundancy.

In operation S541, the electronic device 1200 (e.g., the recovery device 1240) may generate the event signal based on determining that the first sector is in the second status and may provide the event signal to the device controller 1210. Operation S541 is similar operation S271 of FIG. 4, and thus, duplicative description will be omitted to avoid redundancy.

In operation S542, the electronic device 1200 (e.g., the recovery device 1240) may back up the copy data CD. Operation S542 is similar operation S272 of FIG. 4, and thus, duplicative description may be omitted to avoid redundancy.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

According to some example embodiments of the present disclosure, electronic devices providing a data back-up operation, operating methods thereof, and/or operating methods of an electronic system including the same are provided.

Also, electronic devices with improved data reliability by backing up data to a non-volatile memory device before an uncorrectable error occurs in data of a volatile memory device, operating methods thereof, and/or electronic systems including the same are provided.

While the present disclosure has been described with reference to some example embodiments thereof, it will be apparent to those of ordinary skill in the art that various changes and modifications may be made thereto without departing from the spirit and scope of the present disclosure as set forth in the following claims.

What is claimed is:

1. An operating method of an electronic device which includes a device controller, a volatile memory device, a non-volatile memory device, and a recovery device, the method comprising:
backing up, by the recovery device, copy data of user data stored in the volatile memory device to the non-volatile memory device based on health information of the volatile memory device;
providing, by the device controller, a read request for at least a portion of the user data to the volatile memory device;
performing, by the volatile memory device, an error verification operation based on the read request;
storing, by the volatile memory device, first metadata indicating that an uncorrectable error has occurred, based on a result of the error verification operation;
restoring, by the recovery device, the user data with the copy data, based on a result of monitoring the first metadata of the volatile memory device; and
providing, by the volatile memory device, the at least a portion of the user data to the device controller.

2. The method of claim 1, wherein the backing up includes:
loading, by the recovery device, the health information stored in the non-volatile memory device;
determining, by the recovery device, that a first sector, in which the user data are stored, from among a plurality of sectors of the volatile memory device, is in a first status based on the health information, the first status indicating a status in which a back-up operation is desired; and
backing up, by the recovery device, the copy data to the non-volatile memory device based on the health information.

3. The method of claim 2, wherein the determining includes:
determining, by the recovery device, a number of times of occurrence of an error in the first sector based on the health information; and
determining, by the recovery device, that the first sector is in the first status based on determining that the number of times of the occurrence is bigger than a first threshold value.

4. The method of claim 1, wherein the backing up includes:
providing, by the recovery device, a back-up request for the user data to the volatile memory device based on the health information;
generating, by the volatile memory device, the copy data of the user data;
providing, by the volatile memory device, the copy data to the non-volatile memory device; and
storing, by the non-volatile memory device, the copy data in a first storage space of the non-volatile memory device.

5. The method of claim 4, wherein the storing the copy data by the non-volatile memory device includes:
allocating, by the non-volatile memory device, a first sector of the volatile memory device, in which the user data are stored, to the first storage space among a plurality of storage spaces of the non-volatile memory device; and
storing, by the non-volatile memory device, the copy data in the first storage space.

6. The method of claim 4, wherein the storing the copy data includes:
providing, by the non-volatile memory device, an address of the first storage space to the recovery device;
updating, by the recovery device, a back-up table included in the volatile memory device to indicate that the copy data are backed up; and
updating, by the recovery device, a mapping table included in the volatile memory device based on the address, to indicate that the copy data are stored in the first storage space.

7. The method of claim 1, wherein the restoring the user data with the copy data includes:
monitoring, by the recovery device, the first metadata;
providing, by the recovery device, a recovery request to the non-volatile memory device, based on the result of monitoring the first metadata;
providing, by the non-volatile memory device, the copy data to the volatile memory device; and
replacing, by the volatile memory device, the user data with the copy data.

8. The method of claim 1, wherein the restoring the user data with the copy data includes:
determining, by the recovery device, whether the copy data are backed up, based on a back-up table included in the volatile memory device;
determining, by the recovery device, whether the copy data are stored in any storage space of the non-volatile memory device, based on a mapping table included in the volatile memory device; and
restoring, by the recovery device, the user data with the copy data.

9. The method of claim 1, wherein the performing the error verification operation request includes:
storing, by the volatile memory device, second metadata indicating that a correctable error has occurred, based on the result of the error verification operation;
performing, by the volatile memory device, an error correction operation of the correctable error; and
providing, by the volatile memory device, the at least a portion of the user data to the device controller.

10. The method of claim 9, wherein the storing the second metadata further includes:
updating, by the recovery device, the health information based on the second metadata.

11. The method of claim 9, wherein the storing the second metadata further includes:
determining, by the recovery device, that a first sector, in which the user data is stored, from among a plurality of sectors of the volatile memory device, is in a second status, based on the second metadata and the health information, the second status indicating a status in which a reliability of stored data is lower than a threshold reliability; and
providing, by the recovery device, an event signal to the device controller based on determining that the first sector is in the second status.

12. The method of claim 11, wherein the determining that the first sector is in the second status includes:
determining, by the recovery device, a number of times of occurrence of an error in the first sector based on the second metadata and the health information; and
determining, by the recovery device, that the first sector is in the second status, based on determining that the number of times of the occurrence is bigger than a second threshold value.

13. The method of claim 1, wherein the health information includes error information or temperature information of the volatile memory device.

14. An operating method of an electronic system which includes a host device and an electronic device configured to communicate with the host device, the electronic device including a device controller, a volatile memory device, a non-volatile memory device, and a recovery device, the method comprising:
backing up, by the recovery device, copy data of user data stored in the volatile memory device to the non-volatile memory device based on health information of the volatile memory device;
transmitting, by the host device, a read command for at least a portion of the user data to the electronic device;
providing, by the device controller, a read request for the at least a portion of the user data to the volatile memory device based on the read command;
performing, by the volatile memory device, an error verification operation based on the read request;
storing, by the volatile memory device, metadata indicating that an uncorrectable error has occurred, based on a result of the error verification operation;
restoring, by the recovery device, the user data with the copy data, based on a result of monitoring the metadata of the volatile memory device;
providing, by the volatile memory device, the at least a portion of the user data to the device controller; and
transmitting, by the volatile memory device, the at least a portion of the user data to the host device.

15. The method of claim 14, wherein the backing up includes:
loading, by the recovery device, the health information stored in the non-volatile memory device;
determining, by the recovery device, that a first sector, in which the user data are stored, from among a plurality of sectors of the volatile memory device is in a first status, based on the health information, the first status indicating a status in which a back-up operation is desired; and
backing up, by the recovery device, the copy data to the non-volatile memory device based on the health information.

16. The method of claim 14, wherein the backing up includes:
providing, by the recovery device, a back-up request for the user data to the volatile memory device based on the health information;
generating, by the volatile memory device, the copy data of the user data;
providing, by the volatile memory device, the copy data to the non-volatile memory device; and
storing, by the non-volatile memory device, the copy data in a first storage space of the non-volatile memory device.

17. The method of claim 16, wherein the storing the copy data includes:
providing, by the non-volatile memory device, an address of the first storage space to the recovery device;
updating, by the recovery device, a back-up table included in the volatile memory device to indicate that the copy data are backed up; and
updating, by the recovery device, a mapping table included in the volatile memory device based on the address, to indicate that the copy data are stored in the first storage space.

18. The method of claim 14, wherein the restoring the user data with the copy data includes:
determining, by the recovery device, whether the copy data are backed up, based on a back-up table included in the volatile memory device;
determining, by the recovery device, whether the copy data are stored in any storage space of the non-volatile memory device, based on a mapping table included in the volatile memory device; and
restoring, by the recovery device, the user data with the copy data.

19. The method of claim 14, wherein the performing the error verification operation includes:
storing, by the volatile memory device, second metadata indicating that a correctable error has occurred, based on the result of the error verification operation;
performing, by the volatile memory device, an error correction operation of the correctable error; and
providing, by the volatile memory device, the at least a portion of the user data to the device controller.

20. An electronic device comprising:
a device controller;
a volatile memory device;
a non-volatile memory device; and
a recovery device,
wherein the recovery device is configured to back up copy data of user data stored in the volatile memory device to the non-volatile memory device based on health information of the volatile memory device,
wherein the device controller is configured to provide a read request for at least a portion of the user data to the volatile memory device,
wherein the volatile memory device is configured to perform an error verification operation based on the read request and store metadata indicating that an uncorrectable error has occurred based on a result of the error verification operation,
wherein the non-volatile memory device is configured to store the copy data,
wherein the recovery device is configured to restore the user data with the copy data based on a result of monitoring the metadata of the volatile memory device, and
wherein the volatile memory device is configured to provide the at least a portion of the user data to the device controller.
